(19) United States
(12) Patent Application Publication
(10) Pub. No.: US 2009/0151513 A1
(43) Pub. Date: Jun. 18, 2009

(54) LID OPENING TONGS WITH TORQUE ARM

(76) Inventor: Raymond N. Gross, Easthampton, MA (US)

Correspondence Address: DONALD W. MEEKER, 924 EAST OCEAN FRONT, # E, NEWPORT BEACH, CA, 92661, US

(21) Appl. No.: 11/955,398

(22) Filed: Dec. 13, 2007

(51) Int. Cl. B67B 7/20

(52) U.S. Cl. 81/3.55

(57) ABSTRACT

A first and second rail arms are connected at the proximal end to form universal lid opening thongs. The rail arms pivot open at a distal end for accommodating a container lid therein. Each of the rail arms has a lid gripping surface on an interior portion thereof. A swing out torque arm engages the user's forearm. A friction pad may be positioned under the container to add further ease in opening the container.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

Field of the Invention

The present invention relates to container lid removers and particularly to a universal tong-type lid remover for opening twist-off caps or lids which comprises a first and a second rail arm connected at the proximal end thereof which allows the rail arms to pivot open at a distal end for accommodating a container lid therein, each of the rail arms having a lid gripping surface on an interior portion thereof, the lid opening tongs further comprise an extendable torque arm for engaging the user's forearm and may be used with a friction pad on which the container is set to add further ease in opening the container. Description of Related Art including information disclosed under 37 CFR 1.97 and 1.98

Jar lid wrenches and openers are well known in the art. The majority of which comprise wedging, pliers or tong devices having pivoting arcuate jaws which serve as gripping members around a lid on a container. The pliers or tong-type devices require squeezing and holding the handles together tightly to operate. Individuals suffering from arthritis or carpel tunnel do not have the hand strength to open a jar or to operate the common lid gripping devices available.

U.S. Pat. No. 6,837,131, issued Jan. 4, 2005 to Bitonto, is for a jar opener assembly that includes a torquing tool and an anti-slip pad which are used in conjunction with each other in order to easily remove a lid from a jar by placing the anti-slip pad under the jar and attaching the torquing tool so that a cavity having serrated edges abuts against the jar lid in order to apply torque thereto.

U.S. Pat. No. 7,051,621, issued May 30, 2006 to Halpin, provides a gripping device for gripping twist caps which includes a) opposing substantially coextensive coactive first and second handles having hingedly attached proximal extremities, and opposing distal extremities, respectively, b) opposed confronting first and second inwardly-directed faces carried by the first and second handles, respectively, c) longitudinal, substantially parallel rows of teeth carried by the first handle projecting away from the first inwardly-directed face, and d) longitudinal, substantially parallel rows of teeth carried by the second handle and projecting away from the second inwardly-directed face.

U.S. Pat. No. 1,615,196, issued Jan. 18, 1927 to Lilja, shows a jar opener which has a jar lid covering element that is manually turned and a pad for frictionally engaging and supporting the bottom of the jar.

U.S. Pat. No. 3,999,261, issued Dec. 28, 1976 to Bingaman, claims a pad-type jar gripper with a circular depression in the center for holding the base of a conventional canning jar securely during hot-jar processing, the gripper automatically adjusting for tighter holding when a jar is pressed downward in the pad depression and readily releasing the jar when it is lifted from the pad. The invention comprises a base pad having firm but pliable stubby gripper fingers angled upward from the outer edge of the pad. These fingers are so arranged around the circumference of a circular depression in the pad as to accept the bottom section of a conventional canning jar. The fingers extend up the jar sides sufficiently to prevent the jar from being easily tipped. The bottom part of the pad has a soft center directly beneath the bed of the jar-holding depression. The shape of the pad where the soft material is impressed plus the give of the soft material allows weight or downward pressure applied on the held jar to angle the gripper fingers inward. This activates the gripper fingers causing them to close tightly around the base of the jar. The jar then is gripped securely from below while the jar lid is being tightened with a downward pressure being applied from above. This downward pressure also activates suction indentations underneath the pad to prevent the pad from slipping. This gripper device is also self-adjusting to easily release a jar when weight or pressure is reduced as the jar is lifted from the gripper fingers.

U.S. Pat. No. 2,554,420, issued May 22, 1951 to Okey, describes a combined can, jar and bottle opener. The device is a can opener having handles with jar lid gripping surfaces on the inner faces thereof which, when the device is turned with the can opener end towards the user, are straddled over a jar lid and grip the lid for easier removal. A bottle opener is positioned at a proximal end of one of the handles.

U.S. Pat. No. 6,263,761, issued Jul. 24, 2001 to Ryder, discloses an opener for several different types of pill bottle caps and closures. In the preferred embodiment, the opener is molded as one piece of strong, flexible plastic material that can be repeatedly bent without failing. The opener has the shape of an arch, with a thin section at the top of this arch that acts as a hinge and return spring for the two legs of the arch, which are thicker in section and act as handles to react the forces applied by the user's hand. The inside of each handle has a curved surface with teeth on its inside face to grip the outside of a bottle cap. The inside surface of each handle also has a triangular shaped lug that applies a downward force on the top of a bottle cap, and also applies an upward wedge force to pry a bottle cap free. At the bottom of each handle is a second curved surface, as viewed from below, which also has teeth for gripping the outside of a bottle cap. The side of each handle has a thin section blade which can cut and pry loose the seals on pill bottles, as well as pull the cotton packing from pill bottles.

U.S. Pat. No. 5,161,435, issued Nov. 10, 1992 to Brannon, indicates a container seal removal apparatus comprising a plurality of spring-biased legs mounted relative to one another defining an acute angle therebetween include respective prying and piercing legs pivotally mounted at a common junction relative to the first and second legs. The first and second legs include semi-cylindrical heads arranged whose axes are parallel relative to one another, and each including an abutment flange to engage a container seal subsequent to its piercing and prying relative to a neck portion of a container.

U.S. Pat. No. 2,729,125, issued Jan. 3, 1956 to Krzanowski, puts forth a pivoted lever-type container cap remover with a cutter. The device comprises a pair of handles pivotally connected together at a proximal end, each of which has a jaw that when closed together grip a jar lid or a bottle cap.

Two U.S. patents, U.S. Pat. No. 2,691,909, issued Oct. 19, 1954 and U.S. Pat. No. 2,651,226 issued Sep. 8, 1953 to Hopmann, concern a pry-type lid lifter having a pair of lever handles connected pivotally together at a proximal end. Each of the lever handles has a toothed jaw which is slid over a jar lid, on either side of the lid to form a cap wrenching and removing tool.

What is needed is a universal lid remover for opening twist-off caps or lids which comprises a first and a second rail arm connected at the proximal end thereof which allows the rail arms to pivot open at a distal end for accommodating a container lid therein, each of the rail arms having a lid gripping surface on an interior portion thereof and an extensible torque arm for engaging the user's forearm which may be used with a friction pad on which the container is set to add further ease in opening the container.

### BRIEF SUMMARY OF THE INVENTION

An object of the present invention is to provide a universal lid remover for opening twist-off caps or lids which comprises a first and a second rail arm connected at the proximal end thereof which allows the rail arms to pivot open at a distal end for accommodating a container lid therein, each of the rail arms having a lid gripping surface on an interior portion thereof and an extensible torque arm for engaging the user's forearm which may be used with a friction pad on which the container is set to add further ease in opening the container.

In brief, the present invention comprises a universal tong-type lid remover for opening twist-off caps or lids which comprises a lid opening tongs having a first and a second rail arm connected at the proximal end thereof which allows the rail arms to pivot open at a distal end for accommodating a container lid therein, each of the rail arms having a lid gripping surface on an interior portion thereof. The lid opening tongs further comprise an extendable torque arm for engaging the user's forearm and may be used with a friction pad on which the container is set to add further ease in opening the container.

The specific purpose of the tongs of the present invention is for removing jar and bottle lids, removing container seals, and grasping a large range of object sizes and shapes.

The major benefit or improvement offered is that the tongs of the present invention are quick and easy to use, and very universal. The ease is realized by distributing the forces required over many body parts, and by accommodating a multitude of lid sizes. The multitude of fits is accomplished by the design.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a top plan view of the lid opening tongs and torque arm device of the present invention being applied to a container lid showing a hand of a user gripping the distal end of the rail arms and the forearm of the user pushing against the torque arm;

FIG. 2 is a partial cross-sectional view taken through 2-2 of FIG. 1 showing the lid opening tongs of FIG. 1 being applied to a container lid;

FIG. 3 is a side elevational view of the lid opening tongs and torque arm device of FIG. 1 being applied to a container lid showing a hand of a user gripping the distal end of the rail arms and the forearm of the user pushing against the torque arm;

FIG. 4 is a side elevational view taken through 4-4 of FIG. 5 showing an interior surface of one of the lid opening tongs and torque arm device of the present invention with the torque arm down in the storage position aligned with the rail arms;

FIG. 5 is a top plan view of the lid opening tongs and torque arm device of FIG. 1 being applied to a smaller container lid showing a horizontal ridge with teeth of the rail arms contacting the container lid to remove it from the container;

FIG. 6 is a partial cross-sectional view taken through 6-6 of FIG. 5 showing of the lid opening tongs and torque arm device of FIG. 1 being applied to a smaller container lid showing a horizontal ridge with teeth of the rail arms contacting the container lid to remove it from the container.

### DETAILED DESCRIPTION OF THE INVENTION

In FIGS. 1-6, a container lid opening tong and pivotable torque arm device 10 comprises a lid opening tong 20 formed of two rail arms 21A and 21B and an extensible torque arm 30 pivotally attached to a proximal end of the rail arms.

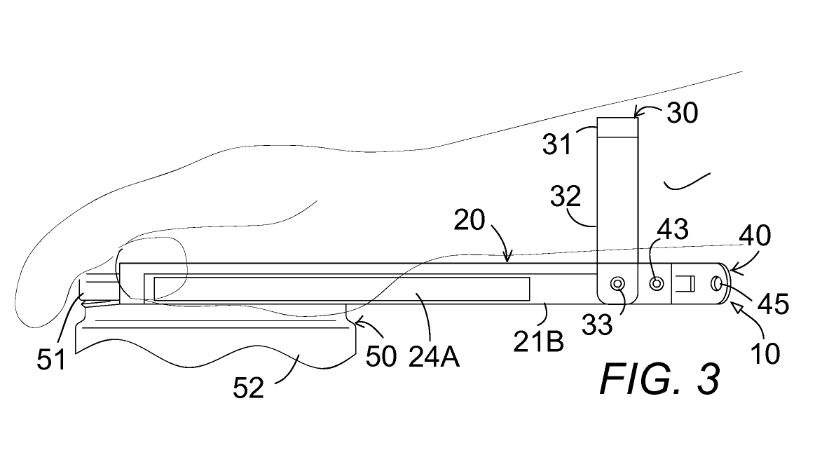

A first rail arm 21A and a second rail arm 21B are attached together by a rail arm pivotable connection 43 at the proximal ends thereof to allow the rail arms to pivot open at a distal end for accommodating a container lid 51 and 51A therebetween. The rail arm pivotal connection comprises at least one of the pivotal connections taken from the list of pivotal connections comprising rail deflection, a pivot pin, a rivet, a hinge, and a leaf spring. Each of the rail arms comprising at least one lid gripping surface 22A and 22B, 23A and 23B, and 24A and 24B on an interior portion thereof. The two rail arms 21A and 21B are squeezed together against the container lid with a first hand of a first arm of a user, as shown in FIGS. 1 and 3, so that the rail arms grip the container lid 51 of a container 50 on opposing sides of the lid. A contoured hand gripping surface 25 on an exterior surface of each of the rail arms enables a user to grip the rail arms securely.

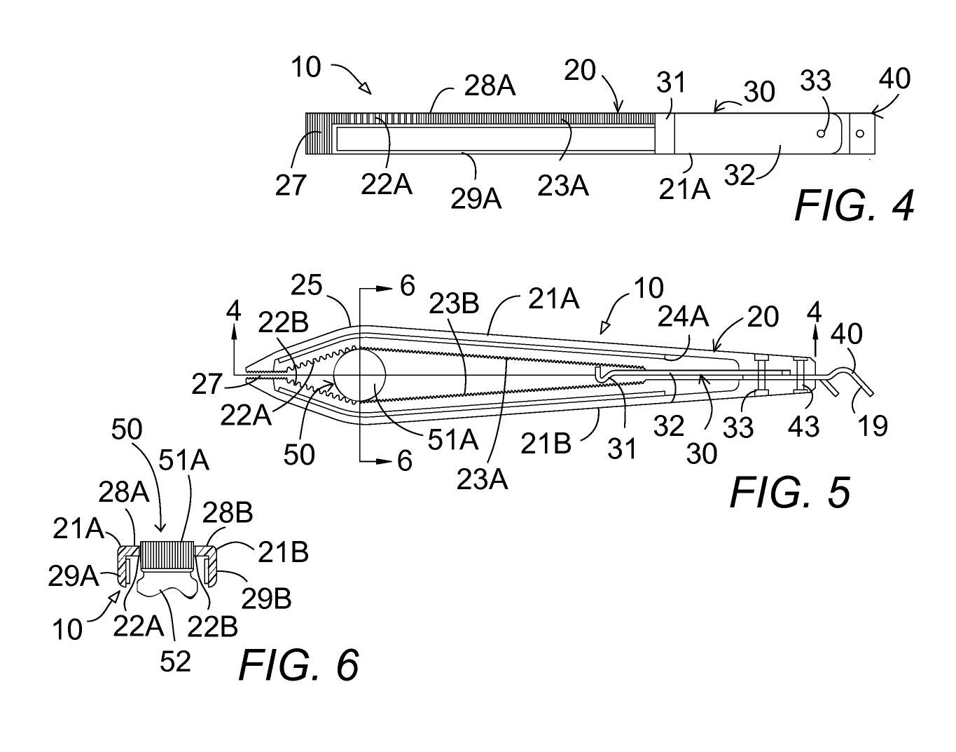

The extensible torque arm 30 is attached to the rail arms by a torque arm pivotable connection 33 at the proximal ends thereof so that the torque arm is pivotable and positionable between a first position aligned with the rail arms for flat storage, as shown in FIGS. 4 and 5, and a second position extending substantially orthogonally from the proximal end of the rail arms for engaging a first forearm on the first arm of the user, as shown in FIG. 3, thereby forming a jar lid opening tong and pivotable torque arm device 10 adjustable to fit a wide variety of container lid sizes to apply force to the torque arm by the first forearm while the first hand squeezes the tongs together around the container lid 51 to create torque to turn the container lid and remove the container lid from a container with the container body 52 held by a second hand of the user. The torque arm may contact the user's forearm, wrist, or hand depending on invention geometry, torque arm extension angle, and user operation.

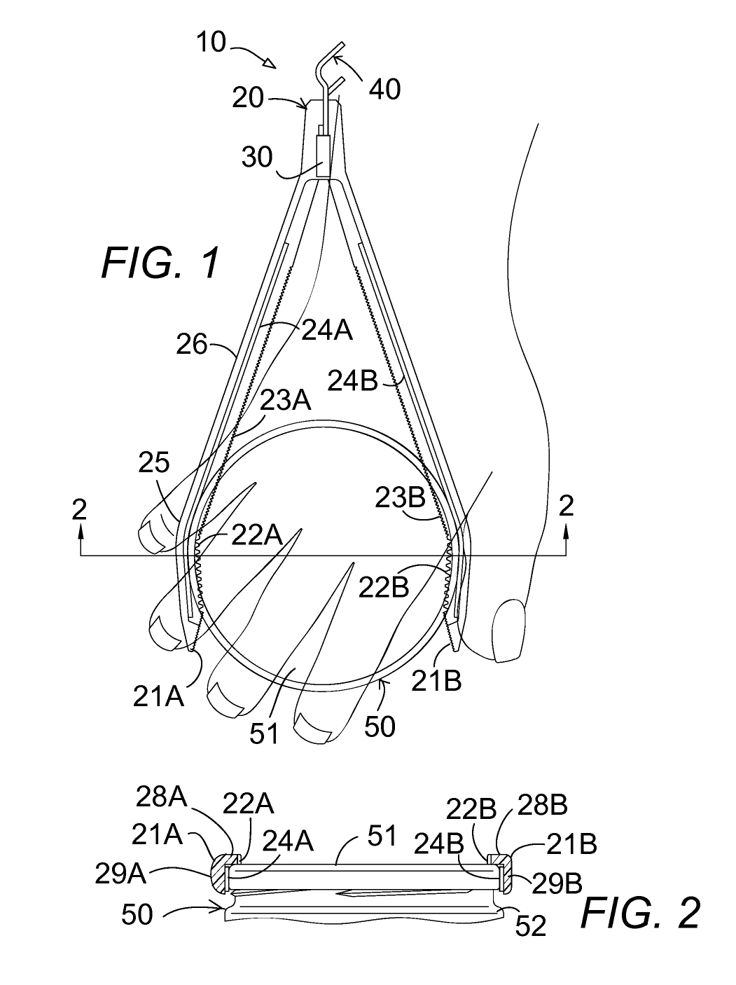

The lid gripping surface preferably comprises a lower vertical wall 29A and 29B covered by a high friction surface 24A and 24B on the interior of the vertical wall to grip a variety of types of container lids 51 and 51A with different outer surfaces around the perimeter of the container lid and an upper horizontal ridge 28A and 28B extending inwardly from the vertical surface so that the horizontal ridge extends over a top of the container lid 51 when using the vertical surface, is shown in FIG. 2. The upper horizontal ridge 28A and 28B bears preferably a double array of spaced teeth, large teeth 22A and 22B adjacent to the distal end and smaller teeth 23A and 23B extending back along the length of the rail arms, as shown in FIGS. 1, 4, and 5, for gripping a variety of types of container lids 51A with textured outer surfaces around the perimeter of the container lid so that the spaced teeth engage the textured outer surfaces and for manipulating child resistant tops which require a firm grip to move the child resistant lid in multiple directions.

The rail arms 21A and 21B comprise at least one arcuate section 25 along the length of the rail arm to curve around a container lid 51 and 51A, as shown in FIGS. 1 and 5.

A bottle cap opener 40 is rigidly attached to the proximal end of the rail arms and preferably has an opening 45 therethrough to hang the device 10, as shown in FIG. 3.

At least one sharp edge 19 would be included on the cap opener 40, as shown in FIG. 4, to sever seals on containers.

Straight gripping surfaces 27 on an interior face of each rail arm at the distal end, as shown in FIG. 5, mate together upon pivoting the rail arms together to form a flat grip to grasp flat material used for sealing containers. The straight gripping surfaces 27 preferably comprise a linear array of closely spaced low profile teeth on each rail arm mating with the straight gripping surface on the opposing rail arm.

A means for locking the torque arm 30 is preferably a laterally protruding end 31 to frictionally engage one of the rail arms to hold it in place in the first position between the rail arms.

The device 10 may further comprise a friction pad (not shown) for use under the container to assist in preventing the container from turning while using the rail arms on the container lid. The friction pad could be made from Dycem, silicone rubber, natural rubber, or other high friction material.

The two tong rail arms 21A and 21B would ideally be made from high density polyurethane (HDP) or other plastic or metal or rigid material, connected (riveted) at the pivot 43 to include a stationary steel bottle opener, and a swing out steel torque arm 30. The inside lining 24A and 24B of the rail arm vertical would be lower density polyurethane (LDP) attached to the rail arms with adhesive or other mechanical fastening means.

In use, the tongs 20 of the present invention would normally be closed in a flat configuration for storage. To open them, one rail is set against the outside of the lid to be grasped. Then the other rail is pulled open over the other side of the lid. The two rails are squeezed together against the lid with one hand, as shown in FIGS. 1 and 3. The tongs grip the lid sides. The other hand would secure the jar body 52 by pushing the jar down on to a friction pad. The squeezing hand also contributes to holding the jar by exerting a downward force creating more friction at the pad.

The horizontal member 28A and 28B of the rail rests on top of the container lid 51 to position the tongs of the present invention properly on the lid sides. This horizontal member also contains gripper teeth 22A and 22B and 23A and 23B used for other applications such as gripping a textured outer surface on a lid and being used to push in and turn a child proof cap, as shown in FIGS. 5 and 6.

The nose of both rails includes a flat 27 used for grasping seals (tabbed “easy” removable container seals, lid seals, sealed bags, etc). The tongs would be equipped with a sharp edge 19 to sever plastic seals (not shown). This invention is especially handy for people with weak wrists and numb fingers from carpal tunnel and arthritis.

It is understood that the preceding description is given merely by way of illustration and not in limitation of the invention and that various modifications may be made thereto without departing from the spirit of the invention as claimed.

What is claimed is:

1. A lid opener and torque arm device comprising:
a lid opener for accommodating a container lid comprising at least one lid gripping surface held onto the container lid with a first hand of a first arm of a user;
a torque arm attached to the lid opener so that the torque arm is extendable substantially orthogonally to the lid top engages a first forearm, wrist, or hand on the first arm of the user, thereby forming a lid opener and torque arm device to apply force to the torque arm by the first forearm, wrist, or hand while the first hand holds the opener around the container lid to create torque to turn the container lid and remove the container lid from a container.

2. The device of claim 1 wherein the torque arm is positionable at a desired angle to the lid opener.

3. A lid opener and torque arm device comprising:
a first rail arm and a second rail arm attached together by a rail arm pivotable connection at the proximal ends thereof to allow the rail arms to pivot open at a distal end for accommodating a container lid therebetween, each of the rail arms comprising at least one lid gripping surface on an interior portion thereof, the two rail arms squeezed together against the container lid with a first hand of a first arm of a user so that the rail arms grip the container lid on opposing sides of the lid;
a torque arm attached to the rail arms at the proximal ends thereof so that the torque arm extends substantially orthogonally from the proximal end of the rail arms for engaging a first forearm, wrist, or hand on the first arm of the user, thereby forming a lid opener and torque arm device adjustable to fit a wide variety of container lid sizes to apply force to the torque arm by the first forearm, wrist, or hand while the first hand squeezes the opener together around the container lid to create torque to turn the container lid and remove the container lid from a container.

4. The device of claim 3 wherein the torque arm is positionable at a desired angle to the lid opener.

5. The device of claim 3 wherein the torque arm is pivotally attached to the rail arms so that the torque arm is pivotable between a first position aligned with the rail arms for flat storage and a second position extending at a desired angle from the distal end of the rail arms for use.

6. The device of claim 3 wherein the at least one lid gripping surface comprises a lower vertical wall with a high friction surface to grip a variety of types of container lids with different outer surfaces around the perimeter of the container lid and an upper horizontal ridge extending inwardly from the vertical surface, the upper horizontal ridge bearing at least one array of spaced teeth for gripping a variety of types of container lids.

7. The device of claim 6 wherein the at least one array of spaced teeth comprises at least two different arrays of spaced teeth having teeth of different sizes and spaces between the teeth of different widths.

8. The device of claim 3 wherein each of the rail arms comprises at least one arcuate section along the length of the rail arm to curve around a container lid.

9. The device of claim 3 further comprising a bottle cap opener attached to and extending from the proximal end of the rail arms, wherein the bottle opener has a hole therethrough for hanging the device.

10. The device of claim 3 further comprising at least one sharp edge to sever seals on containers.

11. The device of claim 3 further comprising straight gripping surfaces on an interior face of each rail arm to mate together upon pivoting the rail arms together to form a flat grip.

12. The device of claim 11 wherein the straight gripping surfaces comprises a linear array of closely spaced low profile teeth on each rail arm mating with the straight gripping surface on the opposing rail arm.

13. The device of claim 3 wherein the rail arm pivotal connection comprises at least one of the pivotal connections taken from the list of pivotal connections comprising rail deflection, a pivot pin, a rivet, a hinge, and a leaf spring.

14. The device of claim 3 further comprising a means for locking the torque arm to hold it in place.

15. The device of claim 3 further comprising a friction pad for use under the container to assist in preventing the container from turning while using the rail arms on the container lid.

16. The device of claim 3 further comprising a contoured hand gripping surface on an exterior surface of a rail arm.
